(19) United States
(12) Patent Application Publication
(10) Pub. No.: US 2002/0113179 A1
(43) Pub. Date: Aug. 22, 2002

(54) Wire type apparatus for hanging vacuum cleaner

(76) Inventor: Young-So Song, Seoul (KR)

Correspondence Address: COLEMAN SUDOL SAPONE, P.C., 714 COLORADO AVENUE, BRIDGEPORT, CT, 06605-1601, US

(21) Appl. No.: 09/824,410

(22) Filed: Apr. 2, 2001

(30) Foreign Application Priority Data
Feb. 16, 2001 (KR) 2001-7659

(51) Int. Cl. F16M 11/00

(52) U.S. Cl. 248/175; 248/302

(57) ABSTRACT

The present invention relates to a wire type apparatus for hanging a vacuum cleaner capable of easily storing a vacuum cleaner and other parts of the same. The wire type apparatus for hanging a vacuum cleaner according to the present invention includes a main wire having a wall hanged clip at a certain portion and forming a body by bending a wire and including a wrinkled pipe hanging member for hanging a wrinkled pipe at a lower portion, a skirt wire welded to a certain portion of the main wire and forming a certain space for receiving a surrounding portion of the vacuum cleaner by bending the wire, a support wire for supporting the skirt wire and a lower portion of the suction port at a lower portion of the skirt wire, and a connection pipe hanging member having an end portion connected to a reinforced wire of the main wire and connected with the hanging member for supporting the connection pipe.

### BACKGROUND OF THE INVENTION

1. Field of the Invention

The present invention relates to a wire type apparatus for hanging a vacuum cleaner, and in particular to a wire type apparatus for hanging a vacuum cleaner capable of easily storing a vacuum cleaner by fabricating a wire type hanging apparatus in a wall hanged structure.

2. Description of the Background Art

Generally, since the volume of a vacuum cleaner used at home is large, it is difficult to store the vacuum cleaner when it is not used. In particular, since the vacuum cleaner is formed of a plurality of elements such as a wrinkled pipe, a suction port, a connection pipe, etc. connected to a body, when using the vacuum cleaner, the above-described elements are assembled, and when not using the same, the above-described elements are disassembled and stored. The wrinkled pipe is wound on the body of the vacuum cleaner.

However, the vacuum cleaner has a large volume and is hard, so that it is not easily folded and stored. In order to overcome the above problems, a box shaped casing is provided for storing the wrinkled pipe and other parts of the vacuum cleaner, and then the body of the vacuum cleaner is placed thereon. However, in the above-described vacuum cleaner, it is possible to easily store the wrinkled pipe and other parts of the vacuum cleaner. However, since the volume of the box shaped casing is too large, it is difficult to store the vacuum cleaner based on a limited space.

### SUMMARY OF THE INVENTION

Accordingly, it is an object of the present invention to provide a wire type apparatus for hanging a vacuum cleaner which overcomes the problems encountered in the conventional vacuum cleaner.

It is another object of the present invention to provide a wire type apparatus for hanging a vacuum cleaner capable of easily storing a vacuum cleaner and other parts of the same.

To achieve the above objects, there is provided a wire type apparatus for hanging a vacuum cleaner according to the present invention which includes a main wire having a wall hanged clip at a certain portion and forming a body by bending a wire and including a wrinkled pipe hanging member for hanging a wrinkled pipe at a lower portion, a skirt wire welded to a certain portion of the main wire and forming a certain space for receiving a surrounding portion of the vacuum cleaner by bending the wire, a support wire for supporting the skirt wire and a lower portion of the suction port at a lower portion of the skirt wire, and a connection pipe hanging member having an end portion connected to a reinforced wire of the main wire and connected with the hanging member for supporting the connection pipe.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating an apparatus for hanging a vacuum cleaner according to the present invention; and

FIG. 2 is a side view illustrating a state that a vacuum cleaner is hanged to a hanging apparatus according to the present invention.

### DETAILED DESCRIPTION OF THE PREFERRED EMBODIMENTS

The embodiments of the present invention will be explained with reference to the accompanying drawings.

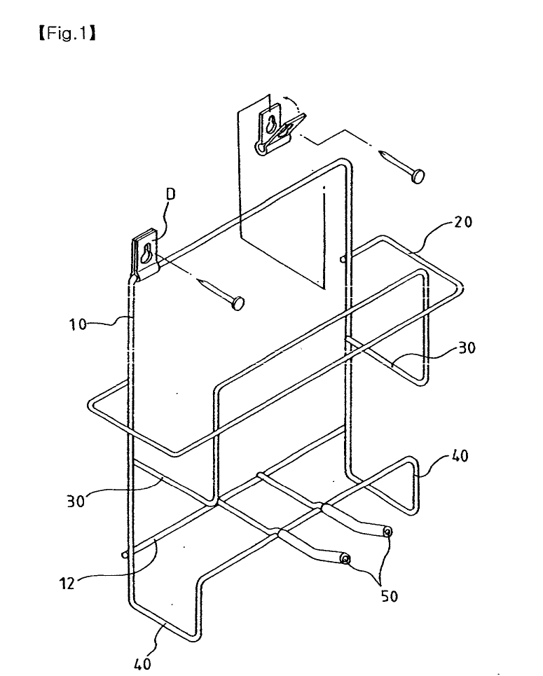

FIG. 1 is a view illustrating an apparatus for hanging a vacuum cleaner according to the present invention. An apparatus for hanging a vacuum cleaner according to the present invention is formed by bending a hard wire and welding the same. The connections of each element are implemented based on a welding method. In the drawings, reference numeral 10 represents a main wire which forms a frame of a hanging apparatus of a vacuum cleaner, 20 represents a skirt wire which surrounds the suction port like a wall and supports the suction port in all directions, 30 represents a support wire which prevents the body of the vacuum cleaner which is supported by the support wire from being dropped, 40 represents a wrinkled pipe hanging member which supports the wrinkled pipe in a wound state, and 50 represents a pipe hanging member which supports the connection pipe which is connected with the wrinkled pipe.

The construction and operation of the wire hanging member according to the present invention will be explained in detail.

The main wire 10 forms a frame by extending and bending a wire in horizontal and vertical directions. In addition, a clip D is engaged to the upper portion for fixing the main wire to the wall using a nail or a screw. A wrinkled pipe hanging member 40 is integrally installed at a lower portion of the main wire 10 for hanging the wrinkled pipe B in the downward and upward directions. In the drawings, reference numeral 12 represents a reinforced wire for providing a lower side of the main wire 10 with respect to leftward and rightward torsion forces.

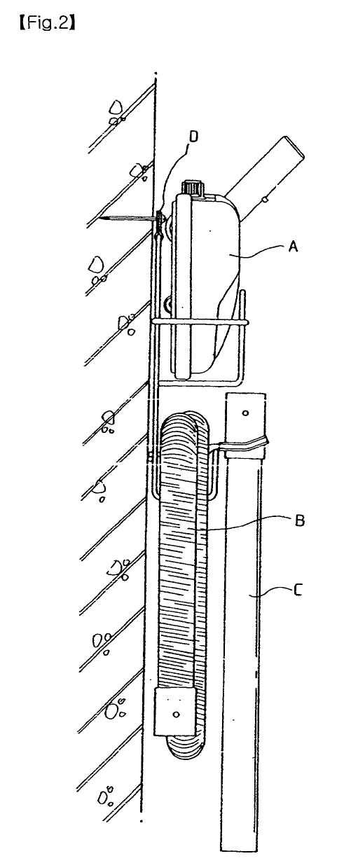

The skirt wire 20 is bent to have a certain space in the horizontal direction on the main wire 10. The above-described space is formed to receive the suction port A. Therefore, as shown in FIG. 2, the movements of the suction port A are prevented by the skirt wire 20.

The support wire 30 fixes both ends to the main wire 10 and extends the same in the forward direction of the main wire and bends the front portion in the upward direction and is welded to the skirt wire 20. Therefore, the suction port A is supported by the portions forwardly extended from both ends of the support wire 30.

A connection pipe C which connects the suction port A and the wrinkled pipe B is hanged on the pipe hanging member 50, and the free ends of a pair of the hanging members 50 are connected with the reinforced wire 12 and are welded to the wrinkled pipe hanging member 40 and includes a certain length extended in a front direction. When the connection pipe C is inserted between the hanging members 50, a portion having a larger diameter is engaged thereto.

When the suction port which is a part of the vacuum cleaner according to the present invention is inserted into the main wire, as shown in FIG. 2, the suction port is inserted, and the wrinkled pipe is wound to the support member for thereby easily storing the same. In addition, the connection pipe is hanged between the hanging members.

As described above, the wall hanged type apparatus for hanging a vacuum cleaner according to the present invention is capable of easily storing the suction port, wrinkled pipe and connection pipe of the vacuum cleaner to a wall and implementing a simplified arrangement and convenient use of the vacuum cleaner.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A wire type apparatus for hanging a vacuum cleaner, comprising:
a main wire having a wall hanged clip at a certain portion and forming a body by bending a wire and including a wrinkled pipe hanging member for hanging a wrinkled pipe at a lower portion;
a skirt wire welded to a certain portion of the main wire and forming a certain space for receiving a surrounding portion of the vacuum cleaner by bending the wire;
a support wire for supporting the skirt wire and a lower portion of the suction port at a lower portion of the skirt wire; and
a connection pipe hanging member having an end portion connected to a reinforced wire of the main wire and connected with the hanging member for supporting the connection pipe.
